(19) United States
(12) Patent Application Publication
(10) Pub. No.: US 2010/0045661 A1
(43) Pub. Date: Feb. 25, 2010

(54) Method and system for converting a two-dimensional (2-D) graphic user interface (GUI) into a GUI with a three-dimensional (3-D) effect

(75) Inventor: Chi-Cheng Chiang, Hsichih (TW)

Correspondence Address: PEARNE & GORDON LLP, 1801 EAST 9TH STREET, SUITE 1200, CLEVELAND, OH, 44114-3108, US

(73) Assignee: ACER INCORPORATED, Hsichih (TW)

(21) Appl. No.: 12/383,637

(22) Filed: Mar. 25, 2009

(30) Foreign Application Priority Data
Aug. 22, 2008 (TW) 097132208

(51) Int. Cl. G06T 15/00

(52) U.S. Cl. 345/419

(57) ABSTRACT

A method for converting a two-dimensional (2-D) graphic user interface (GUI) into a GUI with a three-dimensional (3-D) effect includes: defining a GUI display region on a screen, the GUI display region being defined by first and second curved lines that are spaced apart from each other in a first direction, and first and second boundary lines that intersect the first and second curved lines, distances between pairs of points respectively on the first and second curved lines and aligned in the first direction varying in a second direction different from the first direction; performing projection transformation computational processing upon content of the 2-D GUI to result in transformed content; and presenting the transformed content in the GUI display region, the transformed content presenting a 3-D effect. A system that performs the method is also disclosed.

### CROSS-REFERENCE TO RELATED APPLICATION

This application claims priority to Taiwanese Application No. 097132208, filed Aug. 22, 2008, the disclosure of which is incorporated herein by reference.

### BACKGROUND OF THE INVENTION

1. Field of the Invention

This invention relates to a method and system that presents a three-dimensional (3-D) view of a two-dimensional (2-D) graphic user interface (GUI).

2. Description of the Related Art

The windows flip 3-D function in Microsoft's Windows Vista renders a three-dimensional (3-D) view of two-dimensional (2-D) windows in cascade. The 3-D desktop cube function in Linux, on the other hand, renders a 3-D view of 2-D windows in a 3-D cube.

The aforementioned conventional 3-D view-rendering functions are disadvantageous in that, when in the 3-D view, and when a 3-D window is selected, the selected 3-D window as well as the non-selected 3-D windows are all restored back to their original 2-D shape. Moreover, since the user has to flip through the cascaded 3-D windows in the case of the windows flip 3-D function, and since the user has to rotate the 3-D cube to select a 3-D window in the case of the 3-D desktop cube function, selection of a 3-D window with the conventional 3-D view-rendering functions is relatively slow.

### SUMMARY OF THE INVENTION

Therefore, an object of the present invention is to provide a method for converting a two-dimensional (2-D) graphic user interface (GUI) into a GUI with a three-dimensional (3-D) effect and that can overcome the aforesaid drawbacks of the prior art.

Another object of the present invention is to provide a system that performs the method.

According to an aspect of the present invention, a method for converting a 2-D GUI into a GUI with a 3-D effect comprises: defining a GUI display region on a screen, the GUI display region being defined by first and second curved lines that are spaced apart from each other in a first direction, and first and second boundary lines that intersect the first and second curved lines, distances between pairs of points respectively on the first and second curved lines and aligned in the first direction varying in a second direction different from the first direction; performing projection transformation computational processing upon content of the 2-D GUI to result in transformed content; and presenting the transformed content in the GUI display region, wherein the transformed content presents a 3-D effect.

According to another aspect of the present invention, a method for converting a 2-D GUI on a screen into a GUI with a 3-D effect comprises: defining an origin on the screen; defining a first point, which has a distance from the origin different from that of a center of the 2-D GUI to the origin, vertically spaced apart second and third points, a left line, which interconnects the second and third points, vertically spaced apart fourth and fifth points, and a right line, which interconnects the fourth and fifth points, the left and right lines defining a distance therebetween less than that defined between left and right edges of the 2-D GUI; defining a GUI display region on the screen, the GUI display region being defined by first and second curved lines that are vertically spaced apart from each other, and first and second boundary lines that intersect the first and second curved lines, the first and second boundary lines defining a distance therebetween that corresponds to a distance between the left line and the origin and a distance between the right line and the origin, distances between vertically aligned pairs of points respectively on the first and second curved lines varying in a horizontal direction; performing projection transformation computational processing upon content of the 2-D GUI to result in transformed content; and presenting the transformed content in the GUI display region, wherein the transformed content presents a 3-D effect.

According to yet another aspect of the present invention, a system for converting a 2-D GUI on a screen into a GUI with a 3-D effect comprises a detecting module, a calculating module, and a projecting module. The detecting module is operable so as define a first point, vertically spaced apart second and third points, and vertically spaced apart fourth and fifth points. The calculating module is coupled to the detecting module, and is operable so as to define an origin on the screen, left and right lines, and a GUI display region on the screen. The origin has a distance from the first point different from a distance thereof to a center of the 2-D GUI. The left line interconnects the second and third points. The right line interconnects the fourth and fifth points. The left and right lines define a distance therebetween less than that defined between left and right edges of the 2-D GUI. The GUI display region is defined by first and second curved lines that are vertically spaced apart from each other, and first and second boundary lines that intersect the first and second curved lines. The first and second boundary lines define a distance therebetween that corresponds to a distance between the left line and the origin and a distance between the right line and the origin. Distances between vertically aligned pairs of points respectively on the first and second curved lines vary in a horizontal direction. The projecting module is coupled to the calculating module, and is operable so as to perform projection transformation computational processing upon content of the 2-D GUI to result in transformed content and so as to present the transformed content in the GUI display region. The transformed content presents a 3-D effect.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram of the preferred embodiment of a system for converting a two-dimensional (2-D) graphic user interface (GUI) into a GUI with a three-dimensional (3-D) effect according to this invention;

FIGS. 2 to 4 are schematic diagrams illustrating conversion of a 2-D window into a window with a 3-D effect;

FIG. 5 is a flow chart of the preferred embodiment of a method for converting a 2-D GUI into a GUI with a 3-D effect to be implemented using the system in FIG. 1;

FIG. 6 is a schematic view of a plurality of overlapping 2-D windows; and

FIG. 7 is a schematic 3-D view of the 2-D windows in FIG. 6.

### DETAILED DESCRIPTION OF THE PREFERRED EMBODIMENT

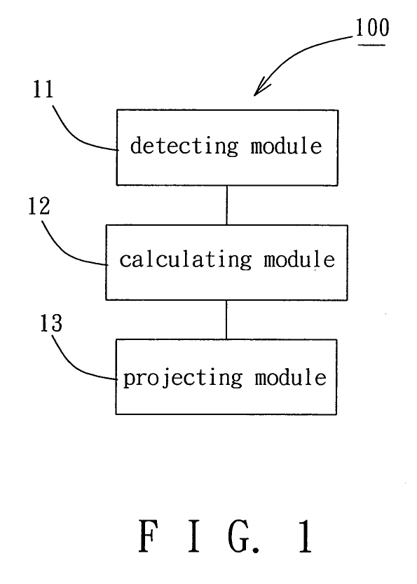

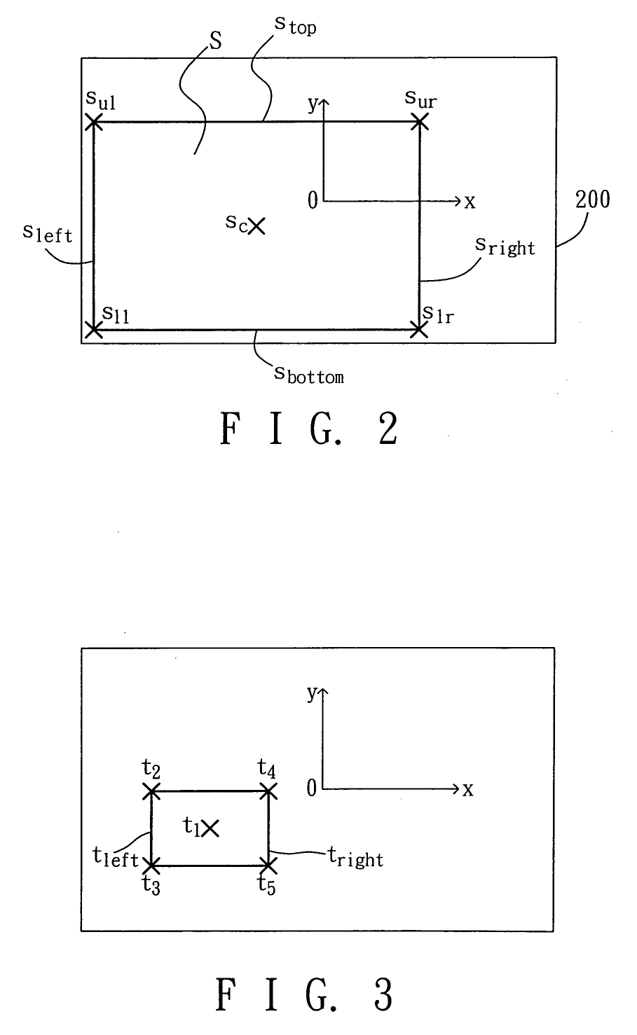

Referring to FIGS. 1 to 4, the preferred embodiment of a system 100 according to this invention is shown to include a detecting module 11, a calculating module 12, and a projecting module 13.

The system 100 of this invention is installed in a computer that includes an operating system (not shown) and a screen 200, and is operable so as to convert a two-dimensional (2-D) graphic user interface (GUI) (S), e.g., a 2-D window, on a screen 200 into a GUI with a three-dimensional (3-D) effect (D), referred to herein as the 3-D GUI.

The 2-D GUI (S) is defined by left and right edges (s_{left}, s_{right}) and top and bottom edges (sₜₒₚ, s_{bottom}), and has upper- and lower-left corners (sᵤₗ, sₗₗ), upper- and lower-right corners (sᵤᵣ, sₗᵣ), and a center (s_{c}).

The detecting module 11 is operable so as to define a first point (t₁), vertically spaced apart second and third points (t₂, t₃), and vertically spaced apart fourth and fifth points (t₄, t₅).

The calculating module 12 is connected to the detecting module 11, and is operable so as to define an origin (O) on the screen 200, a left line (t_{left}) that interconnects the second and third points (t₂, t₃), a right line (t_{right}) that interconnects the fourth and fifth points (t₄, t₅), and a GUI display region (d) on the screen 200.

The GUI display region (d) is defined by first and second curved lines (Lₜₒₚ, L_{bottom}) that are vertically spaced apart from each other, and first and second boundary lines (L_{left}, L_{right}) that intersect the first and second curved lines (Lₜₒₚ, L_{bottom}).

In this embodiment, the first point (t₁) and the origin (O) define a distance therebetween that is inversely proportional to a distance defined between the center (s_{c}) of the 2-D GUI (S) and the origin (O). Moreover, in this embodiment, each of the second and third points (t₂, t₃) and fourth and fifth points (t₄, t₅) has a distance from the first point (t₁) less than that of a respective one of the upper- and lower-left corners (sᵤₗ, sₗₗ) and upper- and lower-right corners (sᵤᵣ, sₗᵣ) of the 2-D GUI (S) to the center (s_{c}) of the 2-D GUI (S). Further, in this embodiment, the left and right lines (t_{left}, t_{right}) define a distance therebetween less than that defined between the left and right edges (s_{left}, s_{right}) of the 2-D GUI (S).

In an alternative embodiment, the distance between the first point (t₁) and the origin (O) has a linear relationship, a cubic relationship, or a quadratic relationship with the distance between the center (s_{c}) of the 2-D GUI (S) and the origin (O).

The projecting module 13 is connected to the calculating module 12, and is operable so as to perform projection transformation computational processing upon content of the 2-D GUI (S) to result in transformed content and so as to present the transformed content in the GUI display region (d). The transformed content presents a 3-D effect.

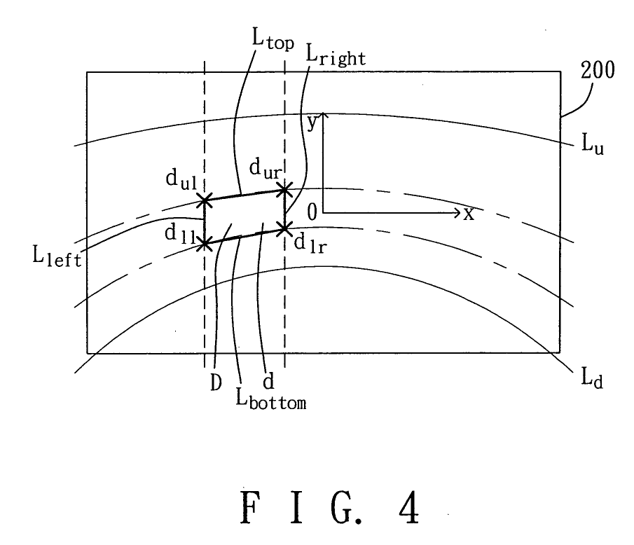

The preferred embodiment of a method for converting the 2-D GUI (S) into the 3-D GUI (D) to be implemented using the aforementioned system 100 according to this invention will now be described with further reference to FIG. 5.

In step 51, the detecting module 11, such as the spy++function in Windows XP, monitors the status of the 2-D GUI (S).

In this step, the detecting module 11 determines whether the 2-D GUI (S) is locked or unlocked, and whether the 2-D GUI (S) is selected, i.e., active, or not selected, i.e., inactive.

In step 52, when it is determined in step 51 that the status of the 2-D GUI (S) is locked, the flow goes back to step 51. Otherwise, the flow proceeds to step 53.

In step 53, when it is determined in step 51 that the status of the 2-D GUI (S) is active, the flow goes back to step 51. Otherwise, the flow proceeds to step 54.

In step 54, the calculating module 12 defines the origin (O) on the screen 200.

In this embodiment, the origin (O) coincides with a center of the screen 200.

In step 55, the detecting module 11 determines original position information of the 2-D GUI (S), which is thereafter stored by the calculating module 12.

In this embodiment, the position information includes coordinates of each of the upper- and lower-left corners (sᵤₗ, sₗₗ), upper- and lower-right corners (sᵤᵣ, sₗᵣ), and the center (s_{c}) of the 2-D GUI (S).

In step 56, the detecting module 11 defines the first point (t₁).

In this embodiment, the first point (t₁) has a coordinate f(p) with respect to the origin (O) given by

$$f ( p ) = \{ \begin{matrix}sign ( p ) \cdot c \cdot \vert p \vert , & \vert p \vert \leq {p}_{t} \\ sign ( p ) \cdot c \cdot {p}_{t} + \frac{( {p}_{max} - c \cdot {p}_{t} )}{{p}_{max} - {p}_{t}} \cdot ( \vert p \vert - {p}_{t} ) , & \vert p \vert > {p}_{t}\end{matrix} \}$$

$${p}_{t} = d \cdot {p}_{max}$$

where pₘₐₓ is a maximum permissible one of x- and y-coordinates of the first point (t₁), p is a corresponding one of x- and y-coordinates of the center (s_{c}) of the 2-D GUI (S), c is a constant greater than 1, d is a constant ranging between 0 and 1, and c ·pₜ<pₘₐₓ.

pₘₐₓ is preferably equal to or greater than 0.

c and d are preferably 2.0 and 0.4, respectively, or 1.5 and 0.5, respectively.

In step 57, the detecting module 11 defines the second and third points (t₂, t₃) and the fourth and fifth points (t₄, t₅).

In this embodiment, each of the second and third points (t₂, t₃) and fourth and fifth points (t₄, t₅) has a coordinate f(p)′ with respect to the origin (O) given by

f(p)′=p_{c}′+e(p′−p_{c})

where p_{c} is one of x- and y-coordinates of the center (s_{c}) of the 2-D GUI (S), p_{c}′ is a corresponding one of x- and y-coordinates of the first point (t₁), p′ is a corresponding one of x- and y-coordinates of a respective one of the upper- and lower-left corners (sᵤₗ, sₗₗ) and the upper- and lower-right corners (sᵤᵣ, sₗᵣ) of the 2-D GUI (S), and e is a constant ranging between 0 and 1.

It is noted that steps 56 and 57 may be performed in reverse.

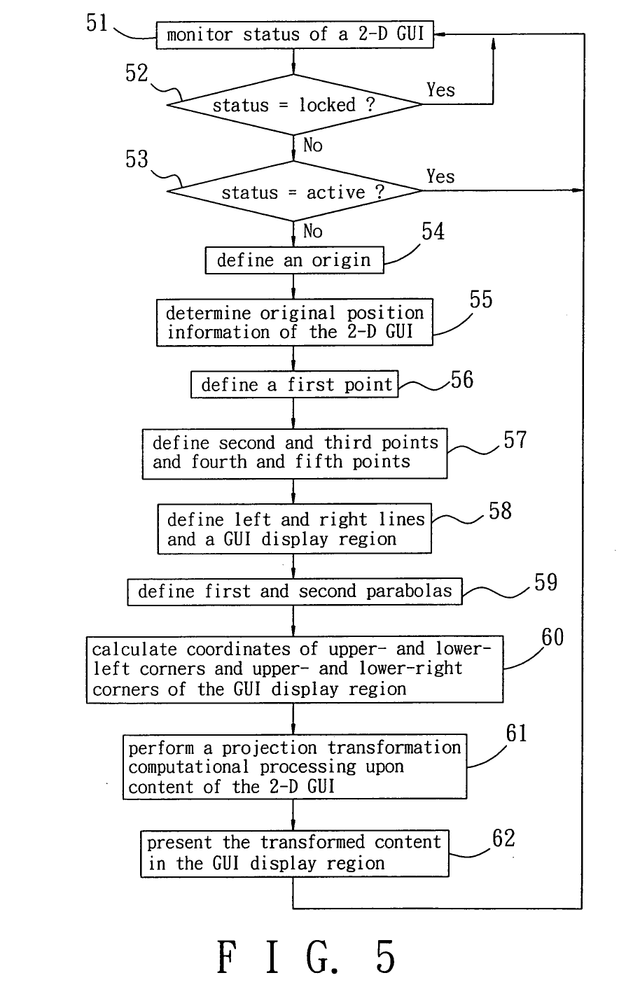

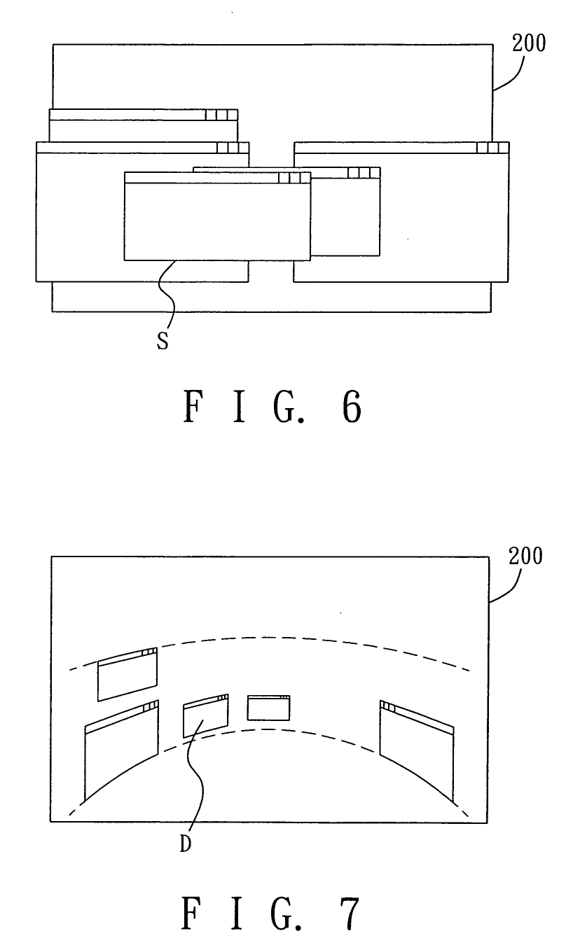

It is further noted that steps 56 and 57 are performed so as to prevent overlapping of 3-D GUIs (D), as illustrated in FIG. 7, in the case where two or more 2-D GUIs (S), as illustrated in FIG. 6, are converted. As such, selection of a 3-D GUI in a 3D view of this invention is relatively fast and easy.

In step 58, the calculating module 12 defines the left and right lines (t_{left}, t_{right}), and the GUI display region (d).

In this embodiment, the first and second boundary lines (L_{left}, L_{right}) of the GUI display region (d) define a distance therebetween that is directly proportional to a distance between the left line (t_{left}) and the origin (O) and a distance between the right line (t_{right}) and the origin (O). In other words, as illustrated in FIG. 7, the nearer the 3-D GUI (D) to the origin (O), the narrower will be the width thereof.

Each of the first and second boundary lines (L_{left}, L_{right}) of the GUI display region (d) has an x-coordinate f(x) with respect to the origin (O) given by

$$f ( x ) = sign ( x ) \cdot [ ( q + 1 ) - \sqrt{{q}^{2} + {( q + 1 )}^{2} - {( \vert x \vert / {x}_{max} + q )}^{2}} ] \cdot {x}_{max}$$

where xₘₐₓ is a maximum permissible x-coordinate of the respective one of the first and second boundary lines (L_{left}, L_{right}), x is an x-coordinate of the respective one of the left and right lines (t_{left}, t_{right}), and q is a constant greater than or equal to 0.

q is preferably 1.

From the above equation, it is apparent that the distance between the first and second boundary lines (L_{left}, L_{right}) gets smaller as q approaches zero.

In an alternative embodiment, the first and second boundary lines (L_{left}, L_{right}) define a distance therebetween that is inversely proportional to a distance between the left line (t_{left}) and the origin (O) and a distance between the right line (t_{right}) and the origin (O). In other words, the nearer the 3-D GUI (D) to the origin (O), the wider will be the width thereof.

In step 59, the calculating module 12 defines first and second parabolas (Lᵤ, L_{d}).

In this embodiment, distances between vertically aligned pairs of points respectively on the first and second parabolas (Lᵤ, L_{d}) vary in a horizontal direction. Moreover, in this embodiment, the first and second parabolas (Lᵤ, L_{d}) have the same axis of symmetry and open downwardly. Further, in this embodiment, the first parabola (Lᵤ) has a focal distance larger than that of the second parabola (L_{d}).

The first parabola (Lᵤ) has a y-coordinate y₁ with respect to the origin (O) given by

y₁=−xₘₐₓ′·g₁·(x₁/xₘₐₓ′)²+yᵥ₁

where xₘₐₓ′ is a maximum permissible x-coordinate of one of the first and second boundary lines (L_{left}, L_{right}), x₁ is an x-coordinate of the first parabola (Lᵤ), yᵥ₁ is a height of the first parabola (Lᵤ), and g₁ is a constant greater than 0.

x₁ is preferably 0.75 of half of the height of the screen 200.

g₁ is preferably 0.15.

The second parabola (L_{d}) has a y-coordinate y₂ with respect to the origin (O) given by

y₂=−xₘₐₓ′·g₂·(x₂/xₘₐₓ′)²+yᵥ₂

where xₘₐₓ′ is a maximum permissible x-coordinate of one of the first and second boundary lines (L_{left}, L_{right}), x₂ is an x-coordinate of the second parabola (L_{d}), yᵥ₂ is a height of the second parabola (L_{d}), g₂ is a constant greater than 0, g₁<g₂, and yᵥ₂>yᵥ₁.

x₂ is preferably −0.35 of half of the height of the screen 200.

g₂ is preferably 0.4.

In an alternative embodiment, the first and second parabolas (Lᵤ, L_{d}) may open upwardly or in different directions.

Each of the first and second curved lines (Lₜₒₚ, L_{bottom}) of the GUI display region (d) has a direct proportional relationship with a respective one of the first and second parabolas (Lᵤ, L_{d}).

The first curved line (Lₜₒₚ) of the GUI display region (d) has a y-coordinate y′ given by

y′=−xₘₐₓ′·g′·(x′/xₘₐₓ′)²+yᵥ′

where x′ is an x-coordinate of the first curved line (Lₜₒₚ) of the GUI display region (d). yᵥ′ is found as

yᵥ′=yᵥ₂+(yₜ+yₘₐₓ′)·(yᵥ₁−yᵥ₂)/(2·yₘₐₓ′), and

g′ is found as

g′=g₁+(yₘₐₓ′−yₜ)·(g₂−g₁)/(2 ·yₘₐₓ′)

where yₘₐₓ′ is a maximum permissible y-coordinate of the first curved line (Lₜₒₚ) of the GUI display region (d) and yₜ is a y-coordinate of one of the second and fourth points (t₂, t₄).

The second curved line (L_{bottom}) of the GUI display region (d) has a y-coordinate y″ given by

y″=−xₘₐₓ′·g″·(x″/xₘₐₓ′)²+yᵥ″

where x″ is an x-coordinate of the second curved line (L_{bottom}) of the GUI display region (d). yᵥ″ is found as

yᵥ″=yᵥ₂+(y+yₘₐₓ″)·(yᵥ₁−yᵥ₂)/(2·yₘₐₓ″), and

g″ is found as

g″=g₁+(yₘₐₓ″−y)·(g₂−g₁)/(2·yₘₐₓ″)

where yₘₐₓ″ is a maximum permissible y-coordinate of the second curved line (L_{bottom}) of the GUI display region (d) and y_{b} is a y-coordinate of one of the third and fifth points (t₃, t₅).

In step 60, the calculating module 12 calculates coordinates of the upper- and lower-left corners (dᵤₗ, dₗₗ) and upper- and lower-right corners (dᵤᵣ, dₗᵣ) of the GUI display region (d) based on the first and second boundary lines (L_{left}, L_{right}) and the first and second curved lines (Lₜₒₚ, L_{bottom}).

In step 61, the detecting module 11, such as the desktop window manager (DWM) function in Windows Vista, performs the projection transformation computational processing upon the content of the 2-D GUI (S).

In this embodiment, step 61 includes the sub-step of defining a perspective transformation matrix such as through imaging geometry and Microsoft's direct3D application program interface (API).

In step 62, the projecting module 13 presents the transformed content in the GUI display region (d) based on the perspective transformation matrix defined in step 61. Thereafter, the flow goes back to step 51.

The method further includes the step of defining a locking command, which locks the 2-D GUI (S) when issued and which is configured in the detecting module 11, and a cancel command, which unlocks the 2-D GUI (S) when issued and which is also configured in the detecting module 11. For instance, suppose the locking command is a key combination, e.g., ctrl+F1. The 2-D GUI (S) may be locked by first selecting the 2-D GUI (S) and then by pressing the ctrl and F1 keys in sequence. Furthermore, suppose the cancel command is also a key combination, e.g., ctrl+F2. The 2-D GUI (S) may be unlocked by first selecting the 2-D GUI (S) and then by pressing the ctrl and F2 keys in sequence.

It is noted that the operating system, e.g., Windows Vista, of the computer keeps a record of the locked 2-D GUIs (S).

The method further includes the following steps:

the system 100 receives a restoring command; and

in response to the restoring command, the system 100 restores the 3-D GUI (D) back to the 2-D GUI (S) based on the original position information stored in step 55.

It is noted that the system 100 receives the restoring command upon selection of the 2-D GUI (S).

From the above description, when one or more of 2-D GUIs (S) on a screen 200 are locked, each of the unlocked inactive 2-D GUIs (S) is converted into a 3-D GUI (D), while each of the locked and/or active 2-D GUI (S) is retained in its original 2-D form. Moreover, when a 3-D GUI (D) is selected, and when the previously selected 2-D GUI (S) is not locked, the currently selected 3-D GUI (D) is restored back to its original 2-D form, the previously active unlocked 2-D GUI (S) is converted into a 3-D GUI (D), and the remaining 3-D GUIs (D) are retained in their 3-D forms. Further, when a 3-D GUI (D) is selected, and when the previously selected 2-D GUI (S) is locked, the currently selected 3-D GUI (D) is restored back to its original 2-D form, the previously selected locked 2-D GUI (S) is retained in its 2-D form, and the remaining 3-D GUIs (D) are retained in their 3-D forms.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for converting a two-dimensional (2-D) graphic user interface (GUI) into a GUI with a three-dimensional (3-D) effect, said method comprising:
A) defining a GUI display region on a screen, the GUI display region being defined by first and second curved lines that are spaced apart from each other in a first direction, and first and second boundary lines that intersect the first and second curved lines, distances between pairs of points respectively on the first and second curved lines and aligned in the first direction varying in a second direction different from the first direction;
B) performing projection transformation computational processing upon content of the 2-D GUI to result in transformed content; and
C) presenting the transformed content in the GUI display region, wherein the transformed content presents a 3-D effect.

2. The method as claimed in claim 1, wherein the first and second curved lines of the GUI display region are each parabolic and have the same axis of symmetry.

3. The method as claimed in claim 2, wherein the first and second curved lines of the GUI display region open in the same direction and have different focal distances.

4. The method as claimed in claim 1, further comprising:
D) defining first and second parabolas, wherein each of the first and second curved lines of the GUI display region has a direct proportional relationship with a respective one of the first and second parabolas.

5. The method as claimed in claim 1, further comprising:
D) determining whether or not the 2-D GUI is locked, wherein steps A) to C) are performed only when it is determined in step D) that the 2-D GUI is not locked.

6. The method as claimed in claim 5, further comprising:
E) defining a locking command, which locks the 2-D GUI when issued, and a cancel command, which unlocks the 2-D GUI when issued.

7. The method as claimed in claim 1, further comprising:
D) determining whether or not the 2-D GUI is selected, wherein steps A) to C) are performed only when it is determined in step D) that the 2-D GUI is not selected.

8. The method as claimed in claim 1, wherein step B) includes the sub-step of defining a perspective projection matrix.

9. A method for converting a two-dimensional (2-D) graphic user interface (GUI) on a screen into a GUI with a three-dimensional (3-D) effect, the 2-D GUI being defined by left and right edges and having a center, said method comprising:
A) defining an origin on the screen;
B) defining a first point, which has a distance from the origin different from that of the center of the 2-D GUI to the origin, vertically spaced apart second and third points, a left line, which interconnects the second and third points, vertically spaced apart fourth and fifth points, and a right line, which interconnects the fourth and fifth points, the left and right lines defining a distance therebetween less than that defined between the left and right edges of the 2-D GUI;
C) defining a GUI display region on the screen, the GUI display region being defined by first and second curved lines that are vertically spaced apart from each other, and first and second boundary lines that intersect the first and second curved lines, the first and second boundary lines defining a distance therebetween that corresponds to a distance between the left line and the origin and a distance between the right line and the origin, distances between vertically aligned pairs of points respectively on the first and second curved lines varying in a horizontal direction;
D) performing projection transformation computational processing upon content of the 2-D GUI to result in transformed content; and
E) presenting the transformed content in the GUI display region, wherein the transformed content presents a 3-D effect.

10. The method as claimed in claim 9, wherein the distance between the first and second boundary lines of the GUI display region is directly proportional to the distance between the left line and the origin and the distance between the right line and the origin.

11. The method as claimed in claim 9, wherein the first and second curved lines of the GUI display region are each parabolic and have the same axis of symmetry.

12. The method as claimed in claim 11, wherein the first and second curved lines of the GUI display region open in the same direction and have different focal distances.

13. The method as claimed in claim 9, further comprising:
F) defining first and second parabolas, wherein each of the first and second curved lines of the GUI display region has a direct proportional relationship with a respective one of the first and second parabolas.

14. The method as claimed in claim 9, wherein the distance between the first point and the origin is inversely proportional to the distance between the center of the 2-D GUI and the origin.

15. The method as claimed in claim 9, wherein the distance between the first point and the origin has a quadratic relationship with the distance between the center of the 2-D GUI and the origin.

16. The method as claimed in claim 9, further comprising:
F) determining whether or not the 2-D GUI is locked, wherein steps A) to E) are performed only when it is determined in step F) that the 2-D GUI is not locked; and
G) defining a locking command, which locks the 2-D GUI when issued, and a cancel command, which unlocks the 2-D GUI when issued.

17. The method as claimed in claim 9, further comprising:
F) determining whether or not the 2-D GUI is selected, wherein steps A) to E) are performed only when it is determined in step F) that the 2-D GUI is not selected.

18. The method as claimed in claim 9, wherein step D) includes the sub-step of defining a perspective transformation matrix.

19. The method as claimed in claim 9, further comprising:
F) storing original position information of the 2-D GUI; and
G) in response to a restoring command, restoring the GUI with a 3-D effect back to the 2-D GUI based on the original position information stored in step F).

20. A system for converting a two-dimensional (2-D) graphic user interface (GUI) on a screen into a GUI with a three-dimensional (3-D) effect, the 2-D GUI being defined by left and right edges and having a center, said system comprising:
a detecting module operable so as define a first point, vertically spaced apart second and third points, and vertically spaced apart fourth and fifth points;
a calculating module coupled to said detecting module, and operable so as to define
an origin on the screen, said origin having a distance from said first point different from a distance thereof to the center of the 2-D GUI,
a left line that interconnects said second and third points,
a right line that interconnects said fourth and fifth points,
said left and right lines defining a distance therebetween less than that defined between the left and right edges of the 2-D GUI, and
a GUI display region on the screen, said GUI display region being defined by first and second curved lines that are vertically spaced apart from each other, and first and second boundary lines that intersect said first and second curved lines, said first and second boundary lines defining a distance therebetween that corresponds to a distance between said left line and said origin and a distance between said right line and said origin, distances between vertically aligned pairs of points respectively on said first and second curved lines varying in a horizontal direction; and
a projecting module coupled to said calculating module, and operable so as to perform projection transformation computational processing upon content of the 2-D GUI to result in transformed content and so as to present the transformed content in the GUI display region, wherein the transformed content presents a 3-D effect.
